(19) United States
(12) Patent Application Publication
(10) Pub. No.: US 2005/0111672 A1
(43) Pub. Date: May 26, 2005

(54) Speaker matcher for use of multiple rooms

(76) Inventor: Chen-Lee Chen, Taichung (TW)

Correspondence Address: NIKOLAI & MERSEREAU, P.A., 900 SECOND AVENUE SOUTH, SUITE 820, MINNEAPOLIS, MN, 55402, US

(21) Appl. No.: 10/724,389

(22) Filed: Nov. 25, 2003

(51) Int. Cl. H04B 3/00

(52) U.S. Cl. 381/81; 381/123; 381/77; 381/80

(57) ABSTRACT

A speaker matcher includes a plurality of selective switches, a first input terminal, a second input terminal, a plurality of power amplifying circuits, a plurality of press switches, a plurality of volume control switches, and a plurality of speaker output terminals. Thus, the different rooms can select different audio sources by switching the selective switches for the different rooms so as to satisfy the requirements of different users. In addition, the different audio sources are output by the speakers for the different rooms.

### BACKGROUND OF THE INVENTION

1. Field of the Invention

The present invention relates to a speaker matcher, and more particularly to a speaker matcher for use of multiple rooms.

2. Description of the Related Art

A conventional speaker selector is connected to each of a plurality of speakers mounted in a plurality of rooms, so that the audio source from the control room can be transmitted to each of the separate rooms by the respective speaker. However, all of the rooms accommodate the same audio source, so that the people located at different rooms have to accept the same audio source and cannot select their favorite audio sources, thereby limiting the versatility of the speaker selector.

### SUMMARY OF THE INVENTION

The primary objective of the present invention is to provide a speaker matcher for use of multiple rooms.

Another objective of the present invention is to provide a speaker matcher, wherein the different rooms can select different audio sources by switching the selective switches for the different rooms so as to satisfy the requirements of different users.

A further objective of the present invention is to provide a speaker matcher, wherein the different audio sources are output by the speakers for the different rooms.

In accordance with the present invention, there is provided a speaker matcher, comprising:

a plurality of selective switches each having a first side and a second side;

a first input terminal externally connected to a plurality of audio sources that are amplified by signals and having a side connected to the first side of each of the selective switches;

a second input terminal externally connected to a plurality of audio sources that have not been amplified by the signals and having a side connected to the second side of each of the selective switches;

a plurality of power amplifying circuits each having a first side connected to the second side of each of the selective switches and a second side connected to the first side of each of the selective switches;

a plurality of press switches each having a first side connected to each of the selective switches;

a plurality of volume control switches each having a first side connected to a second side of each of the press switches; and

a plurality of speaker output terminals each having a first side connected to a second side of each of the volume control switches and a second side connected to a plurality of speakers.

Further benefits and advantages of the present invention will become apparent after a careful reading of the detailed description with appropriate reference to the accompanying drawings.

### BRIEF DESCRIPTION OF THE DRAWINGS

FIG. 1 is a block view of a speaker matcher in accordance with the preferred embodiment of the present invention;

FIG. 2 is a circuit view of a selective switch of the speaker matcher in accordance with the preferred embodiment of the present invention;

FIG. 3 is a circuit view of the press switches and volume control switches of the speaker matcher in accordance with the preferred embodiment of the present invention; and

FIG. 4 is a schematic plan view of the speaker matcher in accordance with the preferred embodiment of the present invention.

### DETAILED DESCRIPTION OF THE INVENTION

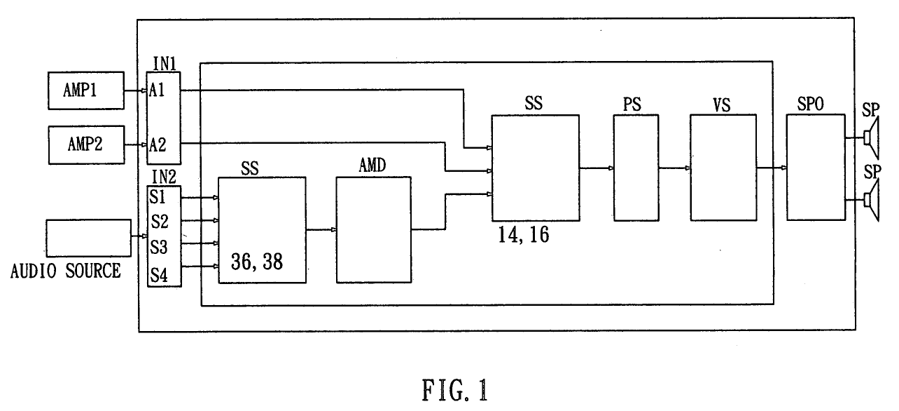

Referring to the drawings and initially to FIGS. 1-3, a speaker matcher in accordance with the preferred embodiment of the present invention comprises a first input terminal IN1, a second input terminal IN2, a plurality of power amplifying circuits AMD, a plurality of selective switches SS, a plurality of press switches PS, a plurality of volume control switches VS, and a plurality of speaker output terminals SPO.

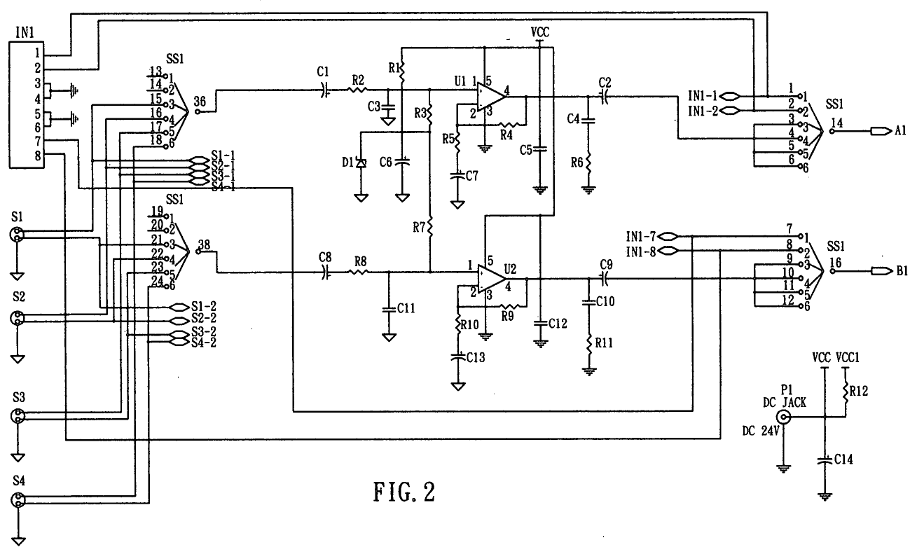

The first input terminal IN1 is externally connected to a plurality of audio sources that are amplified by signals. In the preferred embodiment of the present invention, the first input terminal IN1 is externally connected to two amplifiers AMP1 and AMP2. The first input terminal IN1 has a side connected to a first side of each of the selective switches SS. As shown in FIG. 2, in the preferred embodiment of the present invention, the first input terminal IN1 is connected to the first and second contacts of the first side of a first selective switch SS1, and the first selective switch SS1 outputs signals A1 and A2 through the contacts 14 and 16 of the first selective switch SS1.

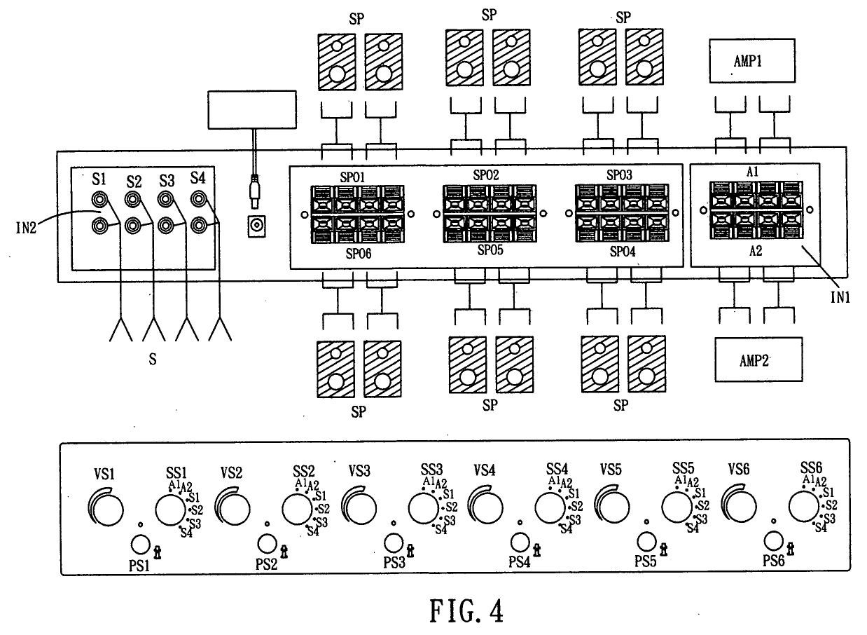

The second input terminal IN2 is externally connected to a plurality of audio sources that have not been amplified by the signals. In the preferred embodiment of the present invention, the second input terminal IN2 is externally connected to four audio sources S (see FIG. 4), such as CD (compact disc) or the like. The second input terminal IN2 has a side connected to a second side of each of the selective switches SS, and the second side of the selective switches SS is connected to the power amplifying circuits AMD which is connected to the first side of each of the selective switches SS. As shown in FIG. 2, in the preferred embodiment of the present invention, the second input terminal IN2 is connected to the third, fourth, fifth and sixth contacts of the second side of the first selective switch SS1, the contacts 36 and 38 of the second side of the first selective switch SS1 are connected to the power amplifying circuits AMD, and the first selective switch SS1 outputs the signals A1 and A2 through the contacts 14 and 16 of the first side of the first selective switch SS1.

The power amplifying circuits AMD are connected to the smaller signal contacts of each of the selective switches SS. Each of the power amplifying circuits AMD has a first side connected to the second side of each of the selective switches SS and a second side connected to the first side of each of the selective switches SS.

As shown in FIG. 2, in the preferred embodiment of the present invention, the power amplifying circuits AMD are connected to the contacts 36 and 38 of the second side of the first selective switch SS1 and the contacts 14 and 16 of the first side of the first selective switch SS 1.

The selective switches SS are connected to the first input terminal IN1, the second input terminal IN2 and the power amplifying circuits AMD. Each of the selective switches SS has a plurality of switch stages. In the preferred embodiment of the present invention, the first input terminal IN1 inputs two audio sources and the second input terminal IN2 inputs four audio sources, so that each of the selective switches SS has six switch stages. The selective switches SS are connected to the press switches PS, so that the input audio sources are selectively switched for use of different rooms.

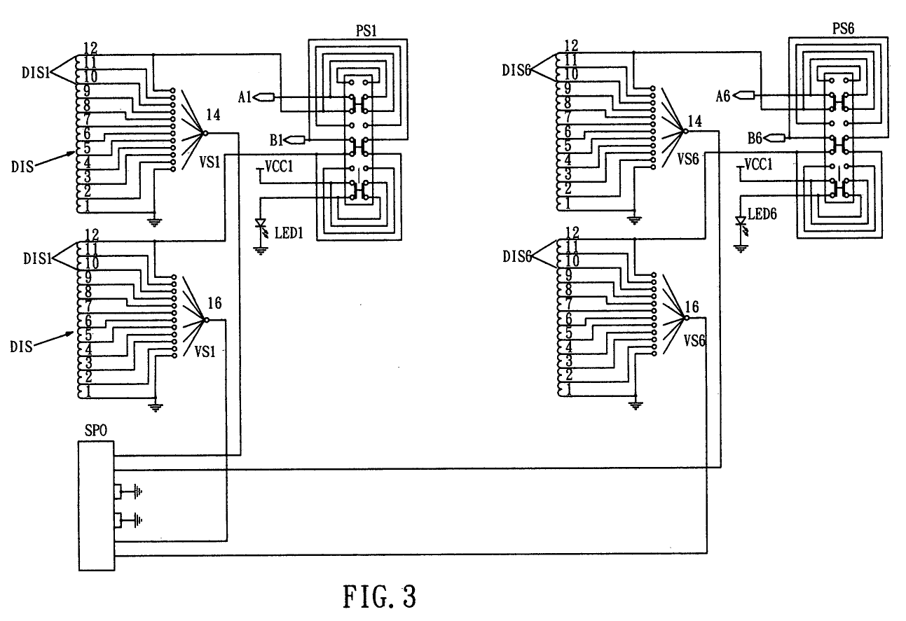

The press switches PS are connected between the selective switches SS and the volume control switches VS, so that the input audio sources are selectively switched for use of different rooms. As shown in FIG. 3, in the preferred embodiment of the present invention, the first and sixth press switches PS1 and PS6 are connected to the first and sixth volume control switches VS1 and VS6 and the speaker output terminals SPO.

The volume control switches VS are connected between the press switches PS and the speaker output terminals SPO and are connected to the selective switches SS through the press switches PS to control the volume output of different rooms. Each of the volume control switches VS has a plurality of coils DIS to function as the matching impedance so as to prevent the volume control switch VS from being worn out when multiple rooms employ the same audio source. As shown in FIG. 3, in the preferred embodiment of the present invention, the first volume control switch VS1 employs the first to ninth coils, and the remaining tenth to twelfth coils DIS1 function as the matching impedance.

The speaker output terminals SPO are connected to the volume control switches VS. Each of the speaker output terminals SPO is connected to a plurality of speakers SP used for different rooms.

Referring to FIG. 4, the selective switches SS are switched for different rooms. In the preferred embodiment of the present invention, the first selective switch SS1, the first press switch PS1, the first volume control switch VS1 and the first speaker output terminal SPO1 are used to control the first room. In such a manner, the first selective switch SS1 is switched to a different audio source, the first press switch PS1 is used to control use of the audio source, the first volume control switch VS1 is used to control the volume of the audio source, and the first speaker output terminal SPO1 is used to output the audio source to the speakers SP of the first room.

Accordingly, the different rooms can select different audio sources by switching the selective switches SS for the different rooms so as to satisfy requirements of different users. In addition, the different audio sources are output by the speakers for the different rooms.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

1. A speaker matcher, comprising:
a plurality of selective switches each having a first side and a second side;
a first input terminal externally connected to a plurality of audio sources that are amplified by signals and having a side connected to the first side of each of the selective switches;
a second input terminal externally connected to a plurality of audio sources that have not been amplified by the signals and having a side connected to the second side of each of the selective switches;
a plurality of power amplifying circuits each having a first side connected to the second side of each of the selective switches and a second side connected to the first side of each of the selective switches;
a plurality of press switches each having a first side connected to each of the selective switches;
a plurality of volume control switches each having a first side connected to a second side of each of the press switches; and
a plurality of speaker output terminals each having a first side connected to a second side of each of the volume control switches and a second side connected to a plurality of speakers.

2. The speaker matcher in accordance with claim 1, wherein the power amplifying circuits are connected to smaller signal contacts of each of the selective switches.

3. The speaker matcher in accordance with claim 1, wherein each of the selective switches has a plurality of switch stages connected to the first input terminal, the second input terminal and the power amplifying circuits.

4. The speaker matcher in accordance with claim 1, wherein each of the selective switches has a plurality of switch stages connected to the press switches, so that input audio sources are selectively switched for use of different rooms.

5. The speaker matcher in accordance with claim 1, wherein the press switches are connected between the selective switches and the volume control switches, so that the input audio sources are selectively switched for use of different rooms.

6. The speaker matcher in accordance with claim 1, wherein the volume control switches are connected between the press switches and the speaker output terminals and are connected to the selective switches through the press switches to control the volume output of different rooms.

7. The speaker matcher in accordance with claim 1, wherein each of the volume control switches has a plurality of coils to function as matching impedance.

8. The speaker matcher in accordance with claim 1, wherein each of the selective switches is switched to a different audio source, each of the press switches is used to control use of the audio source, each of the volume control switches is used to control the volume of the audio source, and each of the speaker output terminals is used to output the audio source to the speakers of the respective room.
